(19) United States
(12) Patent Application Publication
(10) Pub. No.: US 2011/0057955 A1
(43) Pub. Date: Mar. 10, 2011

(54) Apparatus and method for changing screen status in portable terminal

(75) Inventors: Dae Yeon Jeong, Hwaseong-si (KR); Hyun Suk Min, Suwon-si (KR)

(73) Assignee: Samsung Electronics Co., Ltd., Suwon-si (KR)

(21) Appl. No.: 12/807,495

(22) Filed: Sep. 7, 2010

(30) Foreign Application Priority Data
Sep. 7, 2009 (KR) 10-2009-0083799

(51) Int. Cl. G09G 5/00

(52) U.S. Cl. 345/650

(57) ABSTRACT

An apparatus and method controls a screen change in a portable terminal to modify a status (e.g., a screen shift to a specific region or a screen rotation) of a screen being displayed by using a simple touch input. The apparatus includes a screen change unit for displaying a center point for a screen rotation if a touch input is released.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Sep. 7, 2009 and assigned Serial No. 10-2009-0083799, the entire disclosure of which is hereby incorporated by reference.

### TECHNICAL FIELD OF THE INVENTION

The present invention relates to an apparatus and method for controlling a screen change in a portable terminal. More particularly, the present invention relates to an apparatus and method for changing a screen to modify a status of the screen being displayed by using a simple touch input.

### BACKGROUND OF THE INVENTION

Portable terminals have recently been widely used due to convenience of portability. To code with such a trend, service providers (or terminal manufacturers) are competitively developing the portable terminals that include more convenient functions to attract more users.

For example, the portable terminal provides various functions such as phonebooks, games, schedulers, short messaging services, multimedia message services, broadcast message services, Internet services, e-mails, wake-up calls, MPEG Layer 3 (MP3) players, digital cameras, and such.

Recently, in addition to the functions described above, location information intended to be searched for by a user is conveniently provided by using a navigation system, a traffic information communication system, and a 3 Dimensional (3D) map service.

The 3D map service can control a status of a displayed screen, such as a screen shift to a specific region, a screen zoom-in/zoom-out, a screen rotation, and such.

For example, when the user of the portable terminal performs the screen shift while using the 3D map service, the user additionally selects a menu for the screen shift and then touches a map screen being displayed in order to shift the screen to a location desired by the user.

Further, when the user of the portable terminal intends to zoom in or to rotate the screen for a specific region after shifting the screen, the user has to perform the screen touch to shift the screen and then additionally select a menu for the screen zoom-in or the screen rotation in the specific region in order to perform an operation corresponding to the selected menu.

That is, since the user has to select an additional menu to control a screen of a map service being provided, there is a problem in that manipulation is inconvenient.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide an apparatus and method for changing a status of a screen being displayed by using a simple touch input in a portable terminal.

Another aspect of the present invention is to provide an apparatus and method for simplifying a menu execution process for changing a status of a screen being displayed in a portable terminal.

Yet another aspect of the present invention is to provide an apparatus and method for changing a status of a screen in a location at which an input is released, when the input for a screen shift is released in a portable terminal.

In accordance with an aspect of the present invention, an apparatus for changing a screen status in a portable terminal is provided. The apparatus includes a screen change unit for displaying a center point for a screen rotation if a touch input is released.

In accordance with another aspect of the present invention, a method for changing a screen status in a portable terminal is provided. The method includes displaying a center point for a screen rotation if a touch input is released.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal for changing a screen according to an embodiment of the present invention;

FIG. 2 illustrates a screen changing process of a portable terminal according to an embodiment of the present invention;

FIG. 3 illustrates a process of performing a screen rotation as an example of a screen change in a portable terminal according to an embodiment of the present invention;

FIG. 4A illustrates an example of performing a screen shift in a portable terminal according to an embodiment of the present invention; and

FIG. 4B illustrates an example of performing a screen rotation in a portable terminal according to an embodiment of the present invention.

Throughout the drawings, like reference numerals will be understood to refer to like parts, components and structures.

### DETAILED DESCRIPTION OF THE INVENTION

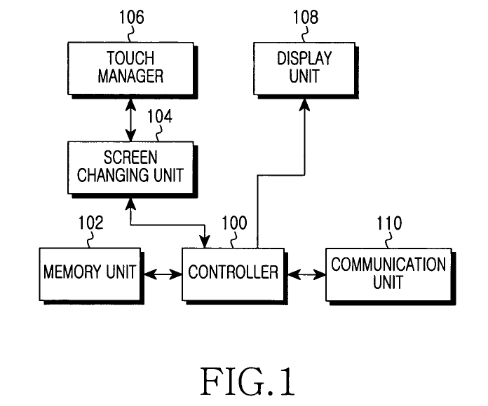

FIGS. 1 through 4B, discussed below, and the various embodiments used to describe the principles of the present disclosure in this patent document are by way of illustration only and should not be construed in any way to limit the scope of the disclosure.

The present invention described below relates to an apparatus and method for changing a status of a screen being displayed by using a simple touch input in a portable terminal, and more particularly, to an apparatus and method for simplifying a process of changing a status of a screen being displayed by allowing a menu for changing the status of the screen to be displayed in a location at which an input is released when the input for shifting the screen being displayed is released.

FIG. 1 illustrates a portable terminal for changing a screen according to an embodiment of the present invention.

As illustrated in FIG. 1, the portable terminal may include a controller 100, a memory unit 102, a screen changing unit 104, a touch manager 106, a display unit 108, and a communication unit 110. The portable terminal may include additional units. Similarly, the functionality of two or more of the above units may be integrated into a single component.

The controller 100 of the portable terminal provides overall control to the portable terminal. For example, the controller 100 controls a processes voice telephony and data communication. According to an embodiment of the present invention, the controller 100 also provides control to change a screen being displayed by using a simple touch input (i.e., a touch input using one finger).

To perform the aforementioned operation, the controller 100 provides control to perform an operation depending on the touch input by detecting the touch input of the user and then, upon detecting the touch input for a screen change, provides control to change a screen in a location at which the input is detected. The controller 100 controls the screen changing unit 104 to change the screen.

When an input for changing the screen change is detected under the control of the controller 100, the screen changing unit 104 of the portable terminal performs a screen change process for changing a status of the screen being displayed. In an embodiment, the screen changing unit 104 can display menus for changing the status of the screen being displayed in a location at which the input for the screen change is detected.

For example, if a touch shift of the user is detected, the screen changing unit 104 shifts the screen being displayed in a direction corresponding to the touch shift of the user, and if a touch input release of the user is detected, the screen changing unit 104 allows a center point for the screen change to be displayed in a location at which the input release is detected. Thereafter, if a screen rotation input of the user is detected at the center point, the screen changing unit 104 provides control to rotate the screen being displayed according to the input.

The memory unit 102 includes, for example, a Read Only Memory (ROM), a Random Access Memory (RAM), a flash ROM, and such. The ROM stores a microcode (i.e., code) of a program, by which the controller 100 and the screen changing unit 104 are processed and controlled, and a variety of reference data.

The RAM is a working memory of the controller 100 and stores temporary data that is generated while programs are executed. The flash ROM stores a variety of rewritable data, such as phonebook entries, outgoing messages, incoming messages, and a variety of rewritable data such as information of the touch input point of the user and, according to an embodiment of the present invention, stores a command corresponding to an input for a pre-defined screen change request.

The touch manager 106 detects the touch input of the user under the control of the controller 100 to perform an operation depending on the touch input. That is, when the touch input of the user is generated, the touch manager 106 may provide a location of a specific point at which the touch input is generated, or the touch manager 106 may determine data corresponding to the location of the specific point and control the display unit 108 to display the data.

The display unit 108 displays information such as state information, which is generated while the portable terminal operates, limited alphanumeric characters, moving pictures, still pictures, and such. The display unit 108 may be a color Liquid Crystal Display (LCD), an Active Mode Organic Light Emitting Diode (AMOLED), and such. The display unit 108 may include a touch input device as an input device when using a touch input type portable terminal.

The communication unit 110 transmits and receives a Radio Frequency (RF) signal of data through an antenna (not illustrated). For example, in a transmitting process, data to be transmitted is subject to a channel-coding process and a spreading process, and then the data is transformed to an RF signal. In a receiving process, the RF signal is received and transformed to a base-band signal, and the base-band signal is subject to a de-spreading process and a channel-decoding process, thereby restoring the data.

Although the function of the screen changing unit 104 can be performed by the controller 100 of the portable terminal, these elements are separately described in the present disclosure only as examples. Thus, those ordinary skilled in the art can understand that various modifications can be made within the scope of the present invention. For example, the functions of the screen changing unit 104 may processed by the controller 100 in another embodiment.

An apparatus for changing a status of a screen being displayed by using a simple touch input in a portable terminal has been described above. An embodiment of a method for simplifying a process of changing a status of a screen being displayed, by allowing a menu for changing the status of the screen to be displayed in a location at which an input is released when the input for shifting the screen being displayed is released, will be described below.

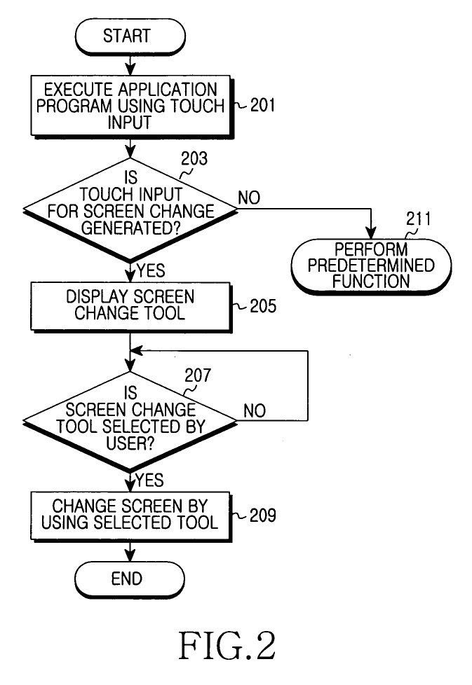

FIG. 2 illustrates a process of a portable terminal according to an embodiment of the present invention.

In block 201, the portable terminal executes an application program that uses a touch input. Herein, the portable terminal executes an application program that uses touch input to change a screen by using one finger. However, the present invention is not limited to the application program that uses the touch input.

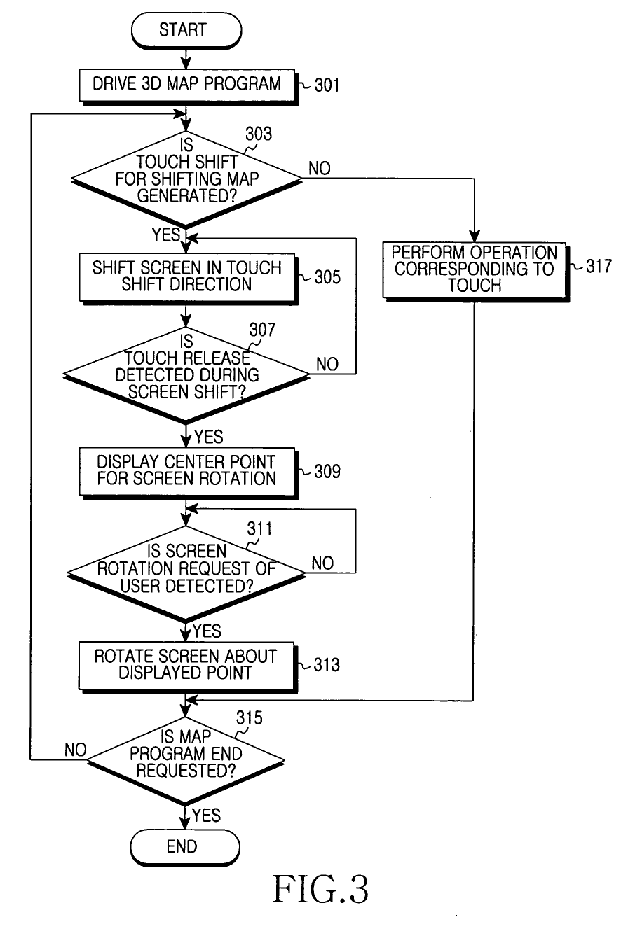

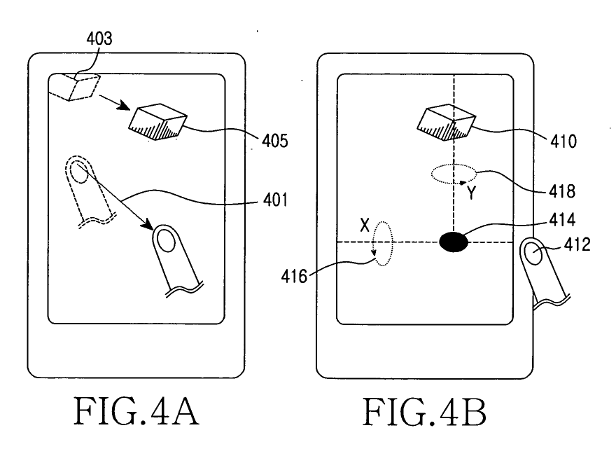

In block 203, the portable terminal determines whether the touch input for executing the screen change is generated. In an embodiment of the present invention, releasing the touch input after a touch shift, as illustrated in FIG. 3 and FIG. 4, is defined as the touch input for performing the screen change.

If it is determined in block 203 that the touch input for performing the screen change is not generated, proceeding to block 211, the portable terminal performs a predetermined function (e.g., an operation corresponding to the touch input of the user).

Alternatively, if it is determined in block 203 that the touch input for performing the screen change is generated, proceeding to block 205, the portable terminal displays a screen change tool. That is, if a normal touch input is detected, the portable terminal performs an operation for that input, and if the touch input for the screen change is detected, the portable terminal displays the screen change tool which is a collection of screen change mechanisms (e.g., a screen shift, a screen zoom-in/zoom-out, a screen rotation, and such).

In block 207, the portable terminal determines whether the user selects the screen change tool to be executed.

If the user does not select the screen change tool in block 207, the process of block 207 is repeated.

Otherwise, if it is determined in block 207 that the user selects the screen change tool, proceeding to block 209, the portable terminal changes the screen being displayed in the portable terminal by using the selected tool.

Thereafter, the procedure of FIG. 2 ends.

FIG. 3 illustrates a process of performing a screen rotation as an example of a screen change in a portable terminal according to an embodiment of the present invention.

In block 301, the portable terminal drives a 3D map program in. In block 303, the portable terminal determines whether a touch shift for shifting a map is generated. Herein, the shifting of the map implies a panning operation that shifts a (specific) location in a map being displayed. When a touch point is shifted in a state where a touch input is performed, the portable terminal can shift the location of the map in a shift direction based on the touch input.

If the touch shift for shifting the location of the map is not generated in block 303, proceeding to block 317, the portable terminal performs a normal operation for performing an operation corresponding to the touch.

Alternatively, if it is determined in step block that the touch shift for shifting the location of the map is generated, proceeding block 305, the portable terminal shifts the location of the map being displayed in the shift direction (i.e. shifts the screen being displayed).

In block 307, the portable terminal determines whether a touch release of a user is detected while the screen is shifted. Herein, when the touch release of the user is generated by an input for a screen change (or a screen rotation), according to an embodiment of the present invention, the portable terminal can perform an operation of rotating the screen being displayed about a location at which the touch input is released.

If it the touch release of the user is not detected in block 307, the process of block 305 is repeated.

Alternatively, if the touch release of the user is detected in block 307, proceeding to block 309, the portable terminal displays a center point for the screen rotation. Herein, the center point for the screen rotation is a point at which the touch is released while the screen being displayed is shifted. The user of the portable terminal can perform 3D search by rotating the displayed screen about the center point.

In block 311, the portable terminal determines whether a screen rotation request of the user is detected. In an embodiment, the portable terminal can detect the screen rotation request of the user by determining whether the center point being displayed is touched.

If the screen rotation request of the user is not detected in block 311, the process of block 311 is repeated. If the touch input of the user is not detected for a specific time period, the portable terminal performs an operation corresponding to a normal map program by allowing the center point to disappear from the screen.

Alternatively, if the screen rotation request of the user is detected in block 311, proceeding to block 313, the portable terminal rotates the screen about the displayed center point. That is, if a user input for performing an up/down shift is detected by touching the center point, the portable terminal rotates a map being displayed about an X-axis, and if a user input for performing a left/right shift is detected by touching the center point, the portable terminal changes the screen being displayed by rotating it about the Y-axis.

In block 315, the portable terminal determines whether an end request of the 3D map program being executed is detected.

If the map program end request is not detected in block 315, returning to block 303, the screen change process of the present invention is repeated.

Alternatively, if the map program end request is detected in block 315, the procedure of FIG. 3 ends.

FIG. 4 illustrates an example of performing a screen rotation as an example of a screen change in a portable terminal according to an embodiment of the present invention.

FIG. 4A illustrates a process of performing a screen shift in a portable terminal according to an exemplary embodiment of the present invention.

FIG. 4A, when a user of the portable terminal intends to perform a panning process for shifting a screen being displayed, the user touches any one portion of the screen being displayed and then performs a touch shift in a desired shift direction while maintaining the touch input (indicated by 401).

As the touch shift is performed in this manner, an entity 403 being displayed is shifted in the touch shift direction by a distance corresponding to the touch shift (indicated by 405).

FIG. 4B illustrates an example of performing a screen rotation in a portable terminal according to an embodiment of the present invention.

FIG. 4B, a user of the portable terminal releases a touch input while performing a touch shift as illustrated in FIG. 4A.

When the touch input is released in this manner (indicated by 412), the portable terminal allows a center point 414 for the screen rotation to be displayed on the screen according to an embodiment of the present invention.

The center point 414 for the screen rotation is a point displayed in a location at which the touch is released while the screen being displayed is shifted. The user of the portable terminal can 3-dimensionally rotate the screen currently being displayed by touching the center point 414. For example, when a square 410 being displayed is rotated to the left and right as illustrated, a coordinate of the screen being displayed is changed by rotating the center point being displayed about a Y-axis (indicated by 418), and if the square 410 being displayed is rotated up and down, the center point being displayed is rotated about an X-axis (indicated by 416) in order to rotate the screen.

The user who uses the portable terminal of the present invention as illustrated in FIG. 4A and FIG. 4B may perform a screen shift and a screen rotation by a simple touch input by using one finger.

That is, the portable terminal of the present invention performs the touch shift, and when the touch is released, displays a Graphic User Interface (GUI) for the screen rotation in a location at which the touch input is released. The location at which the touch input is released becomes the center of the screen rotation, and thus provides an effect capable of determining a center of rotation while releasing the screen shift.

Therefore, the present invention can simplify a process of selecting a plurality of menus when a screen change is performed in the conventional portable terminal.

According to embodiments of the present invention, an apparatus and method for changing a status (e.g., a screen rotation) of a screen being displayed by a simple touch input in a portable terminal is provided. Therefore, when an input for shifting the screen being displayed is released, a menu for changing the screen status is displayed in a location at which the input is released, such that the screen status can be changed more simply than by navigating a sequence of menus for changing the status of the screen being displayed in the conventional portable terminal.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. An apparatus for changing a screen status in a portable terminal, the apparatus comprising a screen change unit configured to display a center point for a screen rotation when a touch input is released.

2. The apparatus of claim 1, further comprising:
a controller configured to detect the touch input, wherein the touch input is a touch interaction that is associated with changing the screen status.

3. The apparatus of claim 1, wherein the screen change unit rotates a screen being displayed about the displayed center point.

4. The apparatus of claim 3, wherein the screen change unit rotates the screen being displayed along an X-axis or a Y-axis about the displayed center point.

5. The apparatus of claim 3, wherein the screen change unit rotates the screen being displayed about the displayed center point in response to a touch interaction that touches the displayed center point.

6. The apparatus of claim 1, wherein the screen change unit displays the center point where the touch input is released.

7. The apparatus of claim 1, wherein the screen change releases the displayed center point for the screen rotation if the touch interaction that touches the displayed center point is not detected for a specific time period.

8. The apparatus of claim 1, wherein if the touch input is associated with a screen shift for shifting the displayed screen, the screen change unit displays the center point for the screen rotation where the touch input associated with the screen shift is released.

9. The apparatus of claim 1, wherein the center point for the screen rotation is a point for indicating a center of rotation the displayed screen.

10. The apparatus of claim 1, wherein the screen change unit releases the displayed center point when a touch interaction associated with ending the screen status change is detected.

11. A method for changing a screen status in a portable terminal, the method comprising displaying a center point for a screen rotation when a touch input is released.

12. The method of claim 1, further comprising:
detecting the touch input, wherein the touch input is a touch interaction that is associated with changing the screen status.

13. The method of claim 11, further comprising, rotating a screen being displayed about the displayed center point.

14. The method of claim 13, wherein rotating the screen being displayed comprises rotating the screen being displayed along an X-axis or a Y-axis about the displayed center point.

15. The method of claim 13, further comprising rotating the screen being displayed about the displayed center point in response to a touch interaction that touches the displayed center point.

16. The method of claim 11, further comprising displaying the center point where the touch input is released.

17. The method of claim 11, further comprising releasing the displayed center point for the screen rotation if the touch interaction that touches the displayed center point is not detected for a specific time period.

18. The method of claim 11, wherein if the touch input is associated with a screen shift for shifting the displayed screen, the center point for the screen rotation is displayed where the touch input associated with the screen shift is released.

19. The method of claim 11, wherein the center point for the screen rotation is a point for indicating a center of rotation of the displayed screen.

20. The method of claim 1, further comprising releasing the displayed center point when a touch interaction associated with ending the screen status change is detected.
